(19) United States
(12) Patent Application Publication
(10) Pub. No.: US 2015/0029917 A1
(43) Pub. Date: Jan. 29, 2015

(54) APPARATUS AND METHOD FOR CONTROLLING MULTI-CARRIER SUPPORTING OPERATION

(71) Applicant: PANTECH CO., LTD., Seoul (KR)

(72) Inventor: Myong Ju KIM, Seoul (KR)

(73) Assignee: PANTECH CO., LTD., Seoul (KR)

(21) Appl. No.: 14/295,236

(22) Filed: Jun. 3, 2014

(30) Foreign Application Priority Data
Jul. 26, 2013 (KR) 10-2013-0088551

(51) Int. Cl. H04W 52/02

(52) U.S. Cl. CPC H04W 52/0209
USPC 370/311

(57) ABSTRACT

Provided is an apparatus and method for not performing an inter-frequency measurement to reduce a current to be used by a terminal providing a multi carrier (MC) function or a carrier aggregation (CA) function. When the terminal satisfies predetermined conditions, the terminal may be operated in a single carrier mode in which the inter-frequency measurement is not performed and thus, a current to be used for the inter-frequency measurement may be reduced.

### CROSS-REFERENCE TO RELATED APPLICATION

This application claims priority from and the benefit of Korean Patent Application No. 10-2013-0088551, filed on Jul. 26, 2013, which is hereby incorporated by reference for all purposes as if fully set forth herein.

### BACKGROUND

1. Field

Exemplary embodiments of the present invention relate to an apparatus and method for controlling multi-carrier supporting operation of a terminal, and more particularly, to an apparatus and method for controlling power consumption of a terminal providing a multi carrier (MC) function or carrier aggregation (CA) function.

2. Discussion of the Background

Various technologies related to mobile communication devices, such as smart phones, have been developed rapidly. Various functions other than phone calls and text message communications are supported by smart phones and evolved smart phones support fast data communication functions using various wireless communication capabilities, such as a multi-carrier function and a carrier aggregation function.

Due to an increase in size of a display and additions of a wireless fidelity (Wi-Fi) function, a near field communication (NFC) function, a long term evolution (LTE) multi carrier (MC) function, and a carrier aggregation (CA) function, evolved smart phones require a considerable amount of power consumption, and the power consumption rates continue to increase at a rapid pace as mobile communication terminals provide more functionalities.

However, the battery capacity of mobile communication terminals have not been increased significantly in comparison with the power consumption rates of evolved mobile communication terminals. Thus, the limited battery capacity has become a major issue in the development of next generation smart phones. In order to increase a standby mode time of a smart phone, a user may use power saving functions for increasing standby mode time of a terminal by setting an economy (eco) mode and/or a power saving mode when a battery level reaches a predetermined level.

However, when a mobile communication terminal supports and utilizes a multi-carrier function and/or a carrier aggregation function and monitor multiple carrier frequencies, the power consumption saving may not be attained.

In order to address such problems, an apparatus and method for controlling multi-carrier supporting function according to exemplary embodiments of the present invention will be described.

### SUMMARY

Exemplary embodiments of the present invention provide a terminal and method for controlling multi-carrier supporting operation.

Additional features of the invention will be set forth in the description which follows, and in part will be apparent from the description, or may be learned by practice of the invention.

Exemplary embodiments of the present invention provide a method that uses a processor to control a multi-carrier supporting operation of a mobile terminal, the method including: determining whether a power saving condition is satisfied; determining whether the mobile terminal is operating in a multi carrier mode or a carrier aggregation mode; and if the power saving condition is satisfied, restricting, by the processor, an inter-frequency measurement of the multi carrier mode or an inter-frequency measurement of the carrier aggregation mode.

Exemplary embodiments of the present invention provide a mobile terminal to control a multi-carrier supporting operation, including: a processor to determine whether a power saving condition is satisfied and to restrict at least one of an inter-frequency measurement of a multi carrier mode and an inter-frequency measurement of a carrier aggregation mode if the power saving condition is satisfied.

Exemplary embodiments of the present invention provide a method that uses a processor to control a multi-carrier supporting operation of a mobile terminal, the method including: determining whether an inter-frequency measurement restriction mode is activated; determining whether a condition to perform an inter-frequency measurement of a multi carrier is mode or an inter-frequency measurement of a carrier aggregation mode is satisfied; and if the inter-frequency measurement restriction mode is activated, restricting, by the processor, the inter-frequency measurement of the multi carrier mode or the inter-frequency measurement of the carrier aggregation mode.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram illustrating a terminal to control multi-carrier operation for power saving according to an exemplary embodiment of the present invention.

FIG. 2 is a graph illustrating a current measurement when an inter-frequency measurement is performed at discontinuous reception (DRX) intervals of an idle time of a terminal providing a multi carrier (MC) function or a carrier aggregation (CA) function according to an exemplary embodiment of the present invention.

FIG. 3 is a graph illustrating a current measurement when a frequency measurement with respect to a neighbor cell is performed at DRX intervals of an idle time of a terminal not providing an MC function or a CA function according to an exemplary embodiment is of the present invention.

FIG. 4 is a diagram illustrating data usage for each application according to an exemplary embodiment of the present invention.

FIG. 5 is a graph illustrating data usage over a time period according to an exemplary embodiment of the present invention.

FIG. 6 is a diagram illustrating a congestion level for each place or each cell according to an exemplary embodiment of the present invention.

FIG. 7 is a flowchart illustrating a method of operating a terminal in a single carrier mode according to an exemplary embodiment of the present invention.

FIG. 8 is a flowchart illustrating a method of re-operating a terminal in an MC mode or a CA mode according to an exemplary embodiment of the present invention.

FIG. 9 is a diagram illustrating a communication system for a case in which an inter-frequency measurement between a terminal and a base station is performed according to an exemplary embodiment of the present invention.

FIG. 10 is a diagram illustrating a communication system for a case in which an inter-frequency measurement between a terminal and a base station is not performed according to an exemplary embodiment of the present invention.

FIG. 11 is a flowchart illustrating a method for controlling a multi carrier supporting operation according to an exemplary embodiment of the present invention.

FIG. 12 is a flowchart illustrating a method for controlling a multi carrier supporting operation according to an exemplary embodiment of the present invention.

FIG. 13 is a flowchart illustrating a method for controlling a multi carrier supporting operation according to an exemplary embodiment of the present invention.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments. Throughout the drawings and the detailed description, unless otherwise described, the same reference numerals will be understood to refer to the same respective elements, features, and structures. The relative size and depiction of these elements may be exaggerated for clarity, illustration, and convenience.

The terminology used herein is for the purpose of describing particular embodiments only and is not intended to be limiting of the present disclosure. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item; similarly, the use of plural terms does not necessarily require plural items and may be understood as one item as need. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

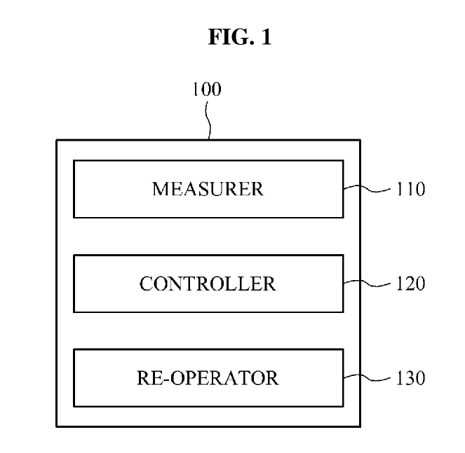

FIG. 1 is a block diagram illustrating a terminal to control multi-carrier operation for power saving according to an exemplary embodiment of the present invention.

Referring to FIG. 1, a terminal 100 may provide a multi carrier (MC) function or a carrier aggregation (CA) function. The terminal 100 may include a measurer 110 to perform an inter-frequency measurement, a controller 120 to control the measurer 110 not to perform the inter-frequency measurement, and a re-operator 130 to operate the measurer 110 to re-perform the inter-frequency measurement.

The measurer 110 may perform an inter-frequency measurement. The inter-frequency measurement may include a measurement of load levels of different frequency bands in a multi carrier (MC) mode. Here, a load may refer to a usage level of a frequency band within a predetermined time with respect to a maximum capability of the frequency band. The load may be a percentage (%) with respect to the maximum capability of the frequency band, but is not limited as such.

The inter-frequency measurement may include a measurement of load levels in frequency bands to be used for communication to determine a frequency band with a higher load level. For example, when a load is relatively high in a currently used frequency band because of numerous users using the frequency band, the load may be distributed to another frequency band. In this instance, an operation of measuring a load level of the other frequency band may be performed before distributing the load to the other frequency band since the load in the other frequency band may be greater than the load of the currently used frequency band. After determining that the other frequency band has a lower load level than the currently used frequency band, the load balancing may be performed by distributing the load of the currently used frequency band to the other frequency band.

A multi carrier (MC) function may provide a user equipment (UE) with a communication function to perform a communication using two or more frequency bands. For example, when traffic is concentrated on a single frequency band and a data rate decreases, the traffic may be distributed to another frequency band to process data more quickly. Accordingly, doubled traffic may be processed physically, and the data rate may also increase. However, since two frequencies are not used simultaneously, the data rate may not increase higher than a data rate at which data may be processed using a single frequency band. In a multi carrier mode in which the multi carrier function is operable, a mobile terminal is capable of switching between multiple frequency bands. For example, a mobile terminal may switch from a first frequency band to a second frequency band without a significant communication interruption. In the multi carrier mode, a mobile terminal may perform an inter-frequency measurement with respect to another frequency band according to a DRX cycle.

A CA may also use multiple frequency bands. However, contrary to the MC, the CA may process data using the two frequency bands simultaneously. Contrary to the MC alternating use of frequency bands in order to use a frequency band with less traffic, the CA may combine the two frequency bands for performing faster data communication. The combination of the two frequency bands may include a combination of two component carriers in a contiguous frequency band. Accordingly, the data rate increases, and the data rate may be much higher than a data rate when a single frequency band is used. In a CA mode in which the CA function is operable, a mobile terminal is capable of utilizing aggregated multiple frequency bands or aggregated multiple component carriers. When carrier aggregation is used, there may be multiple serving cells. One serving cell may have one uplink component carrier and/or one downlink component carrier. However, one serving cell may not have two or more downlink component carriers or two or more uplink component carriers such that any two downlink (or two uplink) component carriers belong to different serving cells. In the multi carrier mode, a mobile terminal may perform an inter-frequency measurement with respect to another frequency band according to a DRX cycle. Further, a mobile terminal may be capable of operating simultaneously in MC and CA mode to perform both MC and CA functions.

However, in a single carrier mode in which a single frequency band is supported, a mobile terminal does not perform a cell searching process in different frequency bands other than the frequency band supported by the single carrier mode. In the single carrier mode, a mobile terminal may perform a frequency measurement of a neighbor cell supporting the same frequency band. However, the mobile terminal does not perform an inter-frequency measurement for different frequency bands other than the single frequency band supported by the single carrier mode.

The terminal 100 may need to measure load levels of different frequency bands is for multi-carrier or carrier aggregation operations. In particular, in the MC, by preventing or reducing an overload situation in a single frequency band, a degradation of a data rate or a delay may be alleviated and the data rate may increase.

To achieve the load balancing and/or the fast data rate by utilizing the MC or the CA, an inter-frequency measurement may be performed, the corresponding measurement report may be transmitted to a base station, and the terminal 100 may transfer to another frequency through an inter-frequency handover based on the report and utilize the other frequency for communication operations.

In the CA, an inter-frequency measurement with respect to another frequency band in which a terminal supports a CA function may be performed, and the measurement report may be transmitted to a base station. Based on the report, the CA function may be performed.

As described above, the terminal 100 may perform an inter-frequency measurement with respect to the currently occupied frequency band and another frequency band at discontinuous reception (DRX) intervals of an idle time.

For example, an operation of controlling the measurer 110 may be interrupted such that the measurer 110 does not to perform the inter-frequency measurement or the measurer 110 may determine to not perform the inter-frequency measurement when the terminal 100 is in an idle state if the terminal 100 determines to reduce power consumption by limiting a portion of or all the operations of the multi-carrier function or the carrier aggregation function.

The terminal 100 may change a mode with respect to the inter-frequency measurement in the idle state. Changing the mode with respect to the inter-frequency measurement may be impossible in a state in which the terminal 100 is connected to a network.

However, a significant amount of current and time may be used for an inter-frequency measurement with respect to another frequency band. Accordingly, when the inter-frequency measurement is performed while a smart phone is in operation, a significant amount of battery power may be consumed by the terminal 100.

In contrast, in a mode using a single frequency band in which the MC function or the CA function is not supported, a terminal does not perform an inter-frequency measurement with respect to another frequency band. The single carrier mode mentioned throughout the specification refers to a mode in which a single frequency band is used.

Since only a frequency measurement with respect to a neighbor cell of a frequency band being used by the terminal may be performed in the single carrier mode, an amount of power consumption required for the frequency measurement and the wake up time duration of the terminal for performing the frequency measurement at DRX intervals of an idle time may be relatively small in comparison with the amount of power consumption and the wake up time duration of the terminal 100 supporting multi-carrier function and/or the carrier aggregation, performing an inter-frequency measurement with respect to different frequency bands concurrently.

To enhance power saving of the terminal 100, the controller 120 may control the measurer 110 not to perform the inter-frequency measurement with respect to different frequency bands other than the occupied frequency band if one or more predetermined conditions are satisfied. Further, if a user input requesting the terminal 100 to be operated in a single carrier mode is received by the terminal 100, the controller 120 may control the measurer 110 not to perform the inter-frequency measurement or limit the inter-frequency measurement such that inter-frequency measurements with respect to different frequency band are not performed.

However, when the user input requesting the terminal 100 to be operated in the is single carrier mode is received while the terminal 100 is receiving data, the terminal 100 may not switch to the single carrier mode immediately. In this example, the controller 120 may control the measurer 110 not to perform the inter-frequency measurement, after completing the data reception, by determining whether the predetermined conditions are satisfied or a user request is received.

The predetermined conditions may include a determination that the remaining battery level is less than a threshold value, an entry of the terminal 100 to a power saving mode, and the like. If the remaining battery level is less than a threshold value, terminals may initiate a power saving mode to reduce battery power consumption, thereby increasing a standby mode time. Accordingly, when the terminal 100 enters the power saving mode, the controller 120 may control the measurer 110 not to perform the inter-frequency measurement that may use a significant amount of power.

The predetermined conditions may include an amount of transmitted data and a data usage history of the terminal 100. The terminal 100 may switch to a single carrier mode based on the determined amount of transmitted data and the data usage history of the terminal 100. If it is determined that a processing of a large volume of data has not been requested more than certain number of time or more than a certain frequency based on the data usage history through the terminal 100 or the amount of transmitted data is less than a certain volume, the MC function or the CA function may not be performed.

Further, the predetermined conditions may include a current time and a current location of the terminal 100. If the terminal 100 is not currently located in an area in which data traffic is congested, a sufficient data rate may be guaranteed in a frequency band currently being used. Accordingly, measuring another frequency band may be unnecessary. In addition, when data traffic is relatively low, e.g., early morning time or late night time, the terminal 100 may determine that the time condition is met and may not perform the MC function or the CA function. Accordingly, a sufficient data rate may be guaranteed in a frequency band currently being used and measuring another frequency band may be unnecessary.

The predetermined conditions may be set based on an execution status of an application of the terminal 100. Each application installed in the terminal 100 may use a large volume of data, or may use a small volume of data.

Accordingly, when an application using a relatively small amount of data is executed, the application may be operated without the MC function or the CA function and the inter-frequency measurement may not be performed.

In addition, since data processing may be rarely requested when only a background application is executed by the terminal 100, the MC function or the CA function may not be performed. Unless a predetermined foreground application that requires high volume of data transmission is executed, the background application may be executed without an interruption or a delay although the terminal 100 is operated in the single carrier mode.

If a display of the terminal 100 is turned off or if a user input is not provided to the terminal 100 for a predetermined period of time, the MC function or the CA function may not be performed and thus the inter-frequency measurement may not be performed.

The re-operator 130 may operate the measurer 110 to re-execute the inter-frequency measurement associated with the MC function or the CA function if one or more predetermined re-execution conditions are met when the terminal 100 is in the single carrier mode.

The predetermined re-execution conditions may include a user input requesting is the re-execution of the MC function or the CA function. Further, the MC function or the CA function may be re-executed after the data reception is terminated if the predetermined re-execution conditions are met while a data communication is performed in the single carrier mode (e.g., receiving a user input requesting the re-execution of the MC function or the CA function while receiving data in the single carrier mode).

Since switching to an MC mode or a CA mode may be impossible while the data is received in the single carrier mode, the single carrier mode of the terminal 100 may be changed to the MC mode or the CA mode when the data reception is terminated and the terminal 100 is operated in an idle state.

The data reception performed as described above may indicate that data may be received continuously in the future. Accordingly, the mode may need to be changed from the single carrier mode to the MC mode or the CA mode.

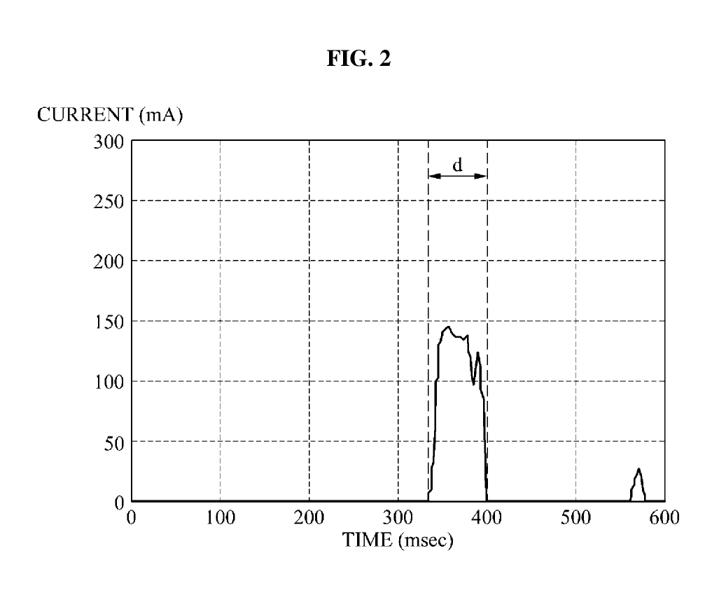

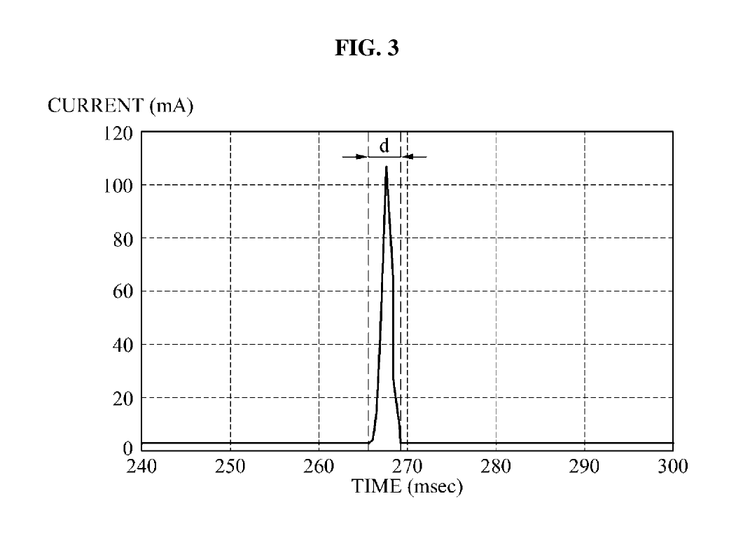

Hereinafter, a current flow for performing an inter-frequency measurement with respect to another frequency band in a multi carrier mode or a carrier aggregation mode and a frequency measurement with respect to a neighbor cell in a single carrier mode will be described with reference to FIG. 2 and FIG. 3, respectively.

FIG. 2 is a graph illustrating a current flow when an inter-frequency measurement is performed at DRX intervals of an idle time of a terminal providing an MC function or a CA function according to an exemplary embodiment of the present invention.

A period of time in which a terminal supporting a MC function or a CA function wakes up for performing a frequency measurement with respect to its own frequency band and an inter-frequency measurement with respect to another frequency band at DRX intervals of an idle time is illustrated in FIG. 2.

The idle time refers to a period of time in which at least a portion of a circuit and a terminal device are in an idle state without performing a communication. DRX refers to a data communication method for reducing power consumption by turning off a reception module or function when data is not transmitted and turning on the reception module or function, according to certain protocols.

Although the terminal is in the idle time, the terminal supporting the MC function or the CA function may require a period of time in which the terminal wakes up for an inter-frequency measurement with respect to another frequency band. As shown in FIG. 2, the wake up time-slot is located between 300 milliseconds (msec) and 400 msec.

The period of time in which the terminal wakes up corresponds to about 70 milliseconds, and a current of about 150 milliamperes (mA) is used for the inter-frequency measurement with respect to the other frequency band. More specifically, a current of 8 to 9 mA may be used for the inter-frequency measurement in the DRX period, excluding other power consuming operations.

The amount of current to be used in inter-frequency measurements in the MA or the CA is significant when battery capacities of current smart phones are considered, and the power consumption caused by the inter-frequency measurements may be a factor of inefficient power usages.

FIG. 3 is a graph illustrating a current flow when a frequency measurement with respect to a neighbor cell is performed at DRX intervals of an idle time of a terminal not providing an MC function or a CA function according to an exemplary embodiment of the present invention.

In a single carrier mode in which an MC function or a CA function is not supported, another frequency band may not be measured. Instead, a frequency measurement with respect to a neighbor cell of a frequency band identical to a frequency band being used by a terminal operated in the single carrier mode may be performed.

In this example, the terminal may require a time in which the terminal wakes up for the frequency measurement with respect to the neighbor cell.

Referring to the graph of FIG. 3, the wake-up time slot length and the amplitude of the current flow for a frequency measurement with respect to a neighbor cell may be relatively small in comparison to the wake-up time slot length and the amplitude of the current flow for an inter-frequency measurement with respect to different frequency bands shown in FIG. 2. The period of time in which the terminal wakes up less than about 70 ms (e.g., about 30 ms), and the peak amplitude of a current is about 100 mA. More specifically, a current of 4 to 6 mA may be used for performing the frequency measurement with respect to a neighbor cell in the DRX period, excluding other power consuming operations.

Since a relatively small amount of current may be used for the single carrier mode, compared to the inter-frequency measurement with respect to the different frequency bands in the MC mode or the CA mode, performing the inter-frequency measurement controlled based on predetermined conditions or a user request may enhance power consumption efficiency. Thus, the battery consumption may be reduced by reducing an amount of current to be used for inter-frequency measurements.

Hereinafter, the predetermined conditions to not perform an inter-frequency measurement with respect to different frequency bands for reducing current usage will be described.

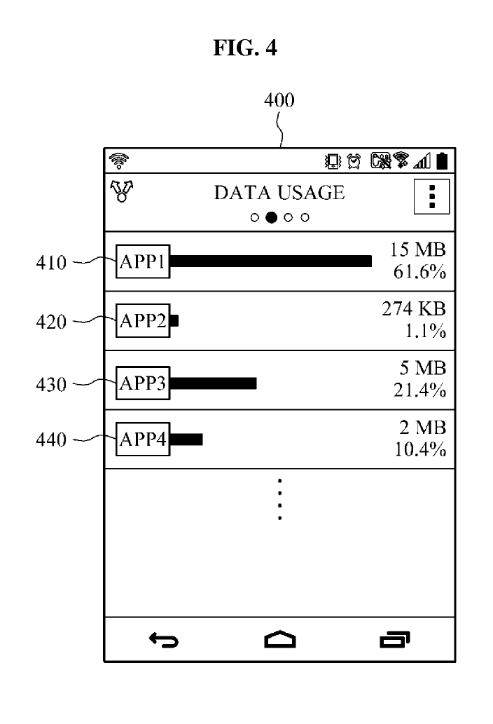

FIG. 4 is a diagram illustrating data usage for each application according to an is exemplary embodiment of the present invention.

Referring to FIG. 4, a data usage history of applications 410, 420, 430, and 440 installed in a terminal of a user may be displayed on a screen 400 configured to display data usage. Usage and frequency of an application may vary depending on a user of the terminal.

An MC function or a CA function may be performed to increase a data rate. Accordingly, when an application using a lower amount of data is executed, the execution may be performed smoothly without using the MC function or the CA function.

Nevertheless, when a terminal is in a multi-carrier or carrier aggregation mode in which the MC function or the CA function is used for the execution of the application using a lower amount of data, an inter-frequency measurement with respect to another frequency band is performed. Accordingly, inefficient power consumption occurs.

To address the problem, the inter-frequency measurement may be controlled based on the data usage history of the applications installed in the terminal of the user. More specifically, when an application using a relatively greater amount of data is used, the terminal may be controlled to be operated in an MC mode or a CA mode. When an application using a relatively smaller amount of data is used, the terminal may be controlled to be operated in a single carrier mode. A threshold data usage amount may be set by a user or may be configured in the terminal. Further, the terminal may calculate an average data usage amount of an application based on the data usage history and may compare the calculated average data usage amount with the threshold data usage amount to determine whether to change the operating mode to the MC mode or the CA mode. Instead of the data usage amount, download completion time of a data traffic may also be used to determine whether to change the operating mode to MC mode or the CA mode. The change of the operating mode to the MC mode or the CA mode may be commanded by a controller if an application having average data usage amount higher than the threshold data usage amount or an application having average download completion time longer than a threshold download completion time is executed or starts a data communication.

Accordingly, inefficient inter-frequency measurement may be reduced and a current to be used by the terminal may be reduced and a standby mode time of a terminal may be extended.

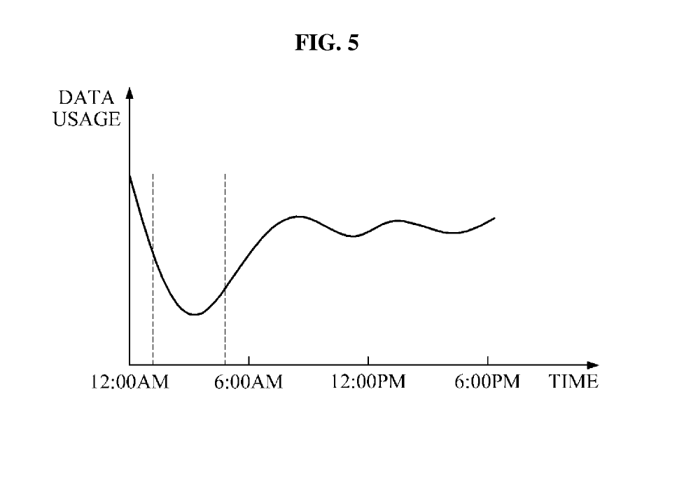

FIG. 5 is a graph illustrating data usage over a time period according to an exemplary embodiment of the present invention.

Referring to FIG. 5, it may be understood that the data usage may vary depending on a time slot. The data usage may increase from around 6:00 a.m., since terminal users may start a day and use mobile terminals in the morning. Further, the data usage may decrease from midnight, since many terminal users may go to sleep and do not use the mobile terminals. The data usage pattern in a given time period, such as a daily data usage pattern, may be analyzed for each terminal user or for each terminal. Further, the data usage pattern may be calculated for each frequency band. The pattern may be used to determine whether to use the MC function or the CA function. Based on the occupancy ratios of available frequency bands, a base station and/or a mobile terminal may determine whether to activate the MC function or the CA function for the mobile terminal.

When data traffic is concentrated on a frequency band as data usage of users increases, an MC function or a CA function may be performed to increase a data rate through an inter-band coupling or an inter-frequency handover such that the relatively high volume of data traffic in the frequency band may be distributed to other less congested frequency bands.

In a time slot, when data usage is relatively high, a user terminal may need to be operated in an MC mode or a CA mode, since a probability that the data traffic may be concentrated on the occupied frequency band may be relatively high in the time slot when data usage of the user terminal is relatively high. Thus, the data rate may decrease if the single carrier mode is maintained.

On the other hand, in a time slot, when data usage is relatively low, the terminal may not need to be operated in the MC mode or the CA mode, since a probability that the data traffic may be concentrated on the occupied frequency band may be relatively low in the time slot when data usage is relatively low. Thus, a data rate may not decrease when the single carrier mode is maintained.

Therefore, single frequency mode and multi carrier mode (or the CA mode) have different advantages and disadvantages in terms of the data rate and the power consumption. If the terminal is operated in the MC mode or the CA mode in all time slots, the user terminal may perform an inter-frequency measurement continuously. Since the inter-frequency measurement requires a predetermined level of current continuously and consumes more battery power, as described with reference to FIG. 2 and FIG. 3, the battery power may be used inefficiently.

Accordingly, when a determination is made, based on data usage for each time slot of a certain period, e.g., a day, as to whether the inter-frequency measurement is to be performed, inefficient inter-frequency measurement may not be performed, and inefficient power consumption of the terminal may be reduced, and an effect of increasing a standby mode time of the terminal may be attained.

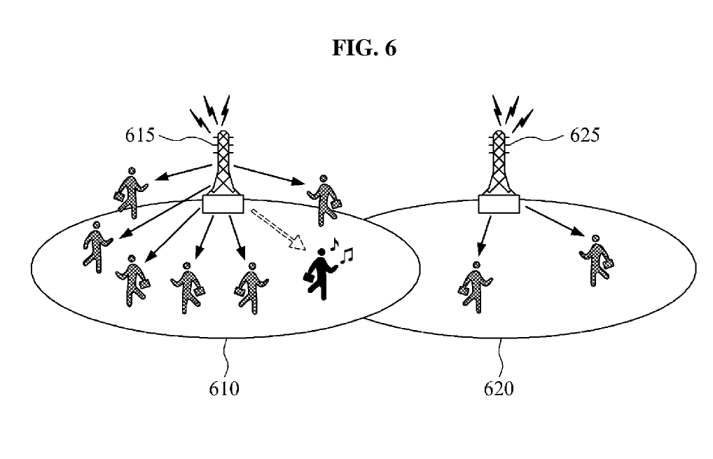

FIG. 6 is a diagram illustrating a congestion level for each place or each cell according to an exemplary embodiment of the present invention.

Referring to FIG. 6, a number of terminals concentrated on a single base station is (or a cell) may vary depending on an area. A relatively large number of terminals may be located in a crowded area, for example, a downtown area. Accordingly, a base station 615 may have relatively higher level of terminal occupancy than a base station 625. Accordingly, the terminal concentration level on the base station 615 may be relatively high.

On the other hand, a relatively fewer number of terminals may be located in a local area, for example, a residential area. Accordingly, the terminal concentration level on the base station 625 may be relatively low. As shown in FIG. 6, more terminals are concentrated on the base station 615 in comparison with the base station 624.

If more terminals are concentrated on the single base station 615, data usage via the base station 615 may increase in proportion to the number of the terminals. Accordingly, data traffic may be concentrated on a predetermined frequency band and thus, a data rate may decrease.

If relatively fewer terminals are concentrated on the base station 625, data usage may not be high. Accordingly, data traffic in a predetermined frequency band may be lower than a reference value and a data rate may not be affected by the data traffic.

As described above, since the data rate may decrease when a relatively great number of terminals are concentrated on the base station 615 and data traffics associated with the terminals concentrated on the base station 615 are higher than a certain reference value, the user terminal may need to be operated in the MC mode or the AC mode to avoid a data rate reduction. Through the MC function or the CA function, data traffic distribution or an inter-band coupling may be performed and thus, the data rate may increase.

On the other hand, since the data rate may not decrease when relatively fewer terminals are concentrated on the base station 625, the user terminal may not need to be operated is in the MC mode or the AC mode. In this instance, when the terminal is operated in the MC mode or the AC mode, the inter-frequency measurement may be performed continuously and the power consumption of the terminal may increase.

Accordingly, conditions to not perform an inter-frequency measurement when relatively fewer terminals are concentrated on the base station 625 may be set depending on a place, a status of a cell, or a status of a neighbor cell. In this example, inefficient inter-frequency measurement may not be performed and a current to be used by the terminal may be reduced and an effect of increasing a standby mode time of the terminal may be attained.

Although the predetermined conditions are described as exemplary embodiments for a case in which an inter-frequency measurement is unnecessary or less efficient when data usage is not relatively high, the predetermined conditions may also be applied to a case in which data processing is unnecessary or a case in which the terminal is to be operated in a power saving mode.

Hereinafter, a method of operating a terminal capable of providing an MC function or a CA function in which an inter-frequency measurement is not performed will be described.

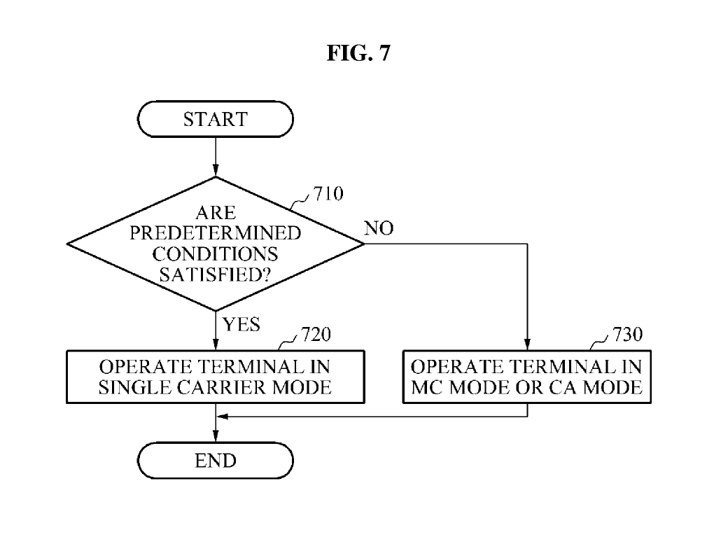

FIG. 7 is a flowchart illustrating a method of operating a terminal in a single carrier mode according to an exemplary embodiment of the present invention.

Referring to FIG. 7, in operation 710, a terminal capable of providing an MC function or a CA function may determine whether one or more conditions for restricting an inter-frequency measurement is satisfied. The one or more conditions may be set based on at least one of a data usage history, an amount of transmitted data, a current time, and a current location of the terminal.

The one or more conditions may correspond to conditions under which the terminal is operable in a single carrier mode in which an inter-frequency measurement with respect to another frequency band may not be performed.

The inter-frequency measurement with respect to another frequency band may be restricted by switching the terminal in the single carrier mode in response to a determination to reduce power consumption. Further, the inter-frequency measurement with respect to another frequency band may be restricted in response to a user request.

If a battery capacity is lower than or equal to a threshold capacity, the terminal may be operated in the single carrier mode for reducing current to be used. Further, it may be determined that the predetermined conditions are satisfied, when data transmission and reception is currently unnecessary or when a user input requesting the terminal to be operated in the single carrier mode is recognized.

Further, a controller may determine that the predetermined conditions are satisfied based on an operating state of the terminal. For example, when a display of the terminal is turned off or a user input is not received by the terminal for a predetermined period of time, the inter-frequency measurement with regard to another frequency band may not be performed.

If it is determined that the terminal satisfies the predetermined conditions in the operation 710, an inter-frequency measurement may not be performed and the terminal may be operated in a single carrier mode, in operation 720.

When the inter-frequency measurement is not performed and the terminal is operated in the single carrier mode, an amount of current to be used by the terminal is reduced and an effect of increasing a standby mode time of the terminal may be attained.

If the terminal does not satisfy the predetermined conditions as determined in the is operation 710, the terminal may be operated continuously in an MC mode or a CA mode, in operation 730, rather than switching to a single carrier mode.

When the terminal does not satisfy the predetermined conditions, e.g., when high speed data processing is necessary or when the terminal does not need to be operated in a power saving mode, the terminal may be operated in the MC mode or the CA mode without switching to the single carrier mode.

If a user request is received, the terminal may be operated in the MC mode or the CA mode, other than the single carrier mode. For example, a user input for requesting a fast data communication may be received and the terminal may be operated in the MC mode or the CA mode.

In the MC mode or the CA mode, a measurer may perform the inter-frequency measurement continuously or periodically and more battery consumption may occur, compared to a case in which the terminal is operated in the single carrier mode.

Hereinafter, a method of re-operating a terminal in an MC mode or a CA mode, when the terminal is operated in a single carrier mode will be described.

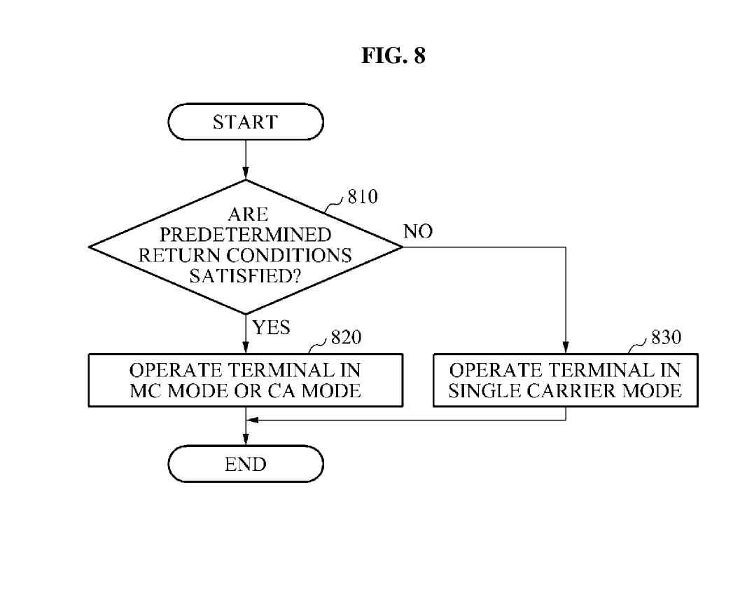

FIG. 8 is a flowchart illustrating a method of re-operating a terminal in an MC mode or a CA mode according to an exemplary embodiment of the present invention.

Referring to FIG. 8, in operation 810, it may be determined whether one or more conditions to re-execute an MC mode or a CA mode. The one or more conditions to re-execute the MC mode or the CA mode may include an input of a user request, or data reception and termination of the data reception.

The terminal may be operated in the single carrier mode when the terminal needs to be operated in a power saving mode, or when the terminal does not need to be operated in an MC mode or a CA mode (e.g., when a processing of a large volume of data is unnecessary).

Accordingly, the conditions to re-execute the MC mode or the CA mode may include a user input requesting the terminal to be re-operated in the MC mode or the CA mode to perform an operation requiring a large volume of data transfer to be processed.

Further, if data is received while the terminal is operated in the single carrier mode, the terminal may return to the MC mode or the CA mode after the data reception is terminated, thereby preparing for future data reception or transmission.

If the conditions to re-execute the MC mode or the CA mode are satisfied as determined in the operation 810, the terminal may be controlled to be re-operated in the MC mode or the CA mode, in operation 820. While the terminal is re-operated in the MC mode or the CA mode, a measurer resumes an inter-frequency measurement and the power consumption of the terminal may increase.

If the conditions to re-execute the MC mode or the CA mode are not satisfied as determined in the operation 810, the terminal may be operated continuously in the single carrier mode, in operation 830. In this instance, the inter-frequency measurement may not be performed continuously.

Hereinafter, a communication system performing an inter-frequency measurement by a terminal capable of providing an MC function and/or a CA function will be described.

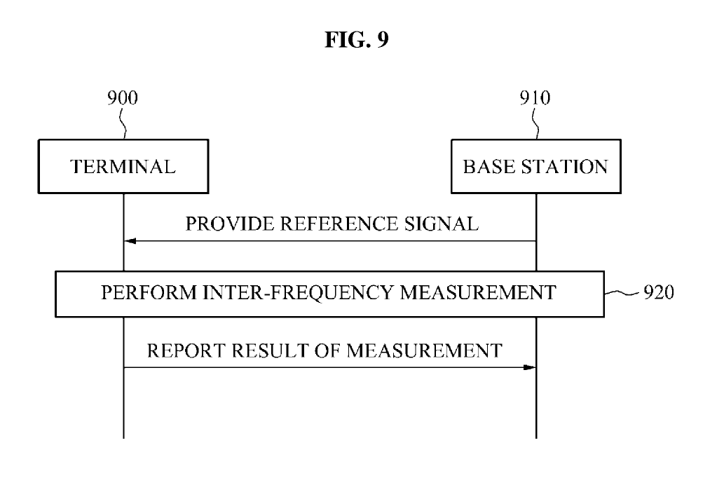

FIG. 9 is a diagram illustrating a communication system for a case in which an inter-frequency measurement between a terminal and a base station is performed according to an exemplary embodiment of the present invention.

Referring to FIG. 9, the communication system may include the terminal 900 and the base station 910, and provide a mechanism for an inter-frequency measurement between the is terminal 900 and the base station 910. When conditions for performing an inter-frequency measurement of a terminal supporting an MC function or a CA function are satisfied, the inter-frequency measurement may be performed.

The conditions may include measurement rules that may vary depending on a value of a reference signal, e.g., Snonintra, provided by the base station 910, and priorities between frequency bands. If a nearby inter-frequency cell having a priority higher than a priority of the cell in which the terminal 900 is currently camped on, the terminal 900 may perform an inter-frequency measurement with respect to the nearby inter-frequency cell at DRX intervals, in operation 920.

Further, the terminal 900 may perform the inter-frequency measurement at DRX intervals when a received signal strength of the terminal 900 measured in the cell in which the terminal 900 is currently camped on is less than the value of the reference signal, e.g., Snonintra, in operation 920. The inter-frequency measurement in the operation 920 may be performed regardless of whether the nearby inter-frequency cell has a priority lower than the priority of the cell in which the terminal 900 is currently camped on. The received signal strength (e.g., received signal level: rxlev) may be indicated by e.g., reference signal received power (RSRP) or received signal strength indicator (RSSI), and the like.

For example, a first frequency band and a second frequency band may be provided and a communication carrier may assign a higher priority to the first frequency band. In this instance, if a terminal is currently camped on the first frequency band, an inter-frequency measurement may not be performed. However, if the terminal is camped on the second frequency band, the inter-frequency measurement with respect to the first frequency band may be performed.

Further, although the terminal is camped on the first frequency band, the inter-frequency measurement may be performed at DRX intervals if received signal strength of the terminal is less than the value of the reference signal.

Further, when the first frequency band and the second frequency band have the same priority, the inter-frequency measurement may be performed continuously or the inter-frequency measurement may be performed if received signal strength of the terminal is less than the value of the reference signal.

More specifically, when the intensity of the received signal of the terminal 900 is less than the value of the reference signal provided by the base station 910, the terminal 900 may perform the inter-frequency measurement, in operation 920, and report the result of the inter-frequency measurement to the base station 910. The terminal 900 may determine whether a handover to another frequency band is to be performed or an inter-band coupling is to be performed based on the report.

As described above, if the value of the reference signal provided by the base station 910 is relatively high, the terminal 900 capable of providing the MC function or the CA function may need to perform the inter-frequency measurement, in operation 920.

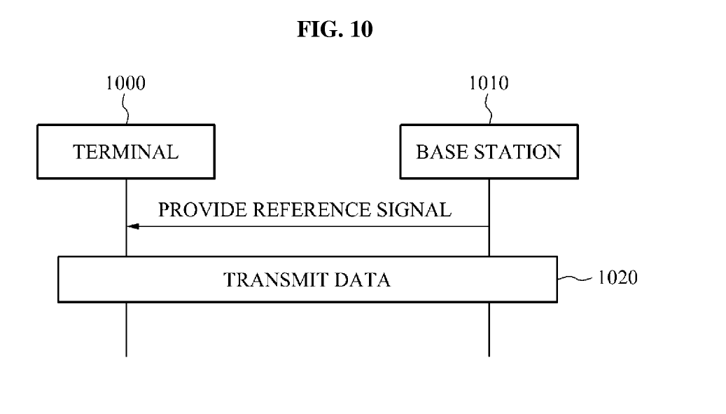

FIG. 10 is a diagram illustrating a communication system for a case in which an inter-frequency measurement between a terminal 1000 and a base station 1010 is controlled according to an exemplary embodiment of the present invention.

When the terminal 1000 is operated in an MC mode or a CA mode, as described with reference to FIG. 9, performing an inter-frequency measurement may be necessary and a certain amount of current may be used for the inter-frequency measurement.

Accordingly, in order to reduce the amount of current to be used, if conditions to is not perform an inter-frequency measurement are satisfied, the terminal 1000 may be controlled to be operated in a single carrier mode or controlled to not perform an inter-frequency measurement although a communication signal of the terminal 1000 does not conform to a reference signal provided by the base station 1010.

Data is transmitted between the terminal 1000 and the base station 1010 in operation 1020; however, the inter-frequency measurement may not be performed when the conditions to not perform an inter-frequency measurement are satisfied.

Accordingly, the terminal 1000 may use an amount of current less than the amount of current to be used for the inter-frequency measurement. In addition, the user may expect an effect of increasing a standby mode time of the terminal as the current to be used decreases.

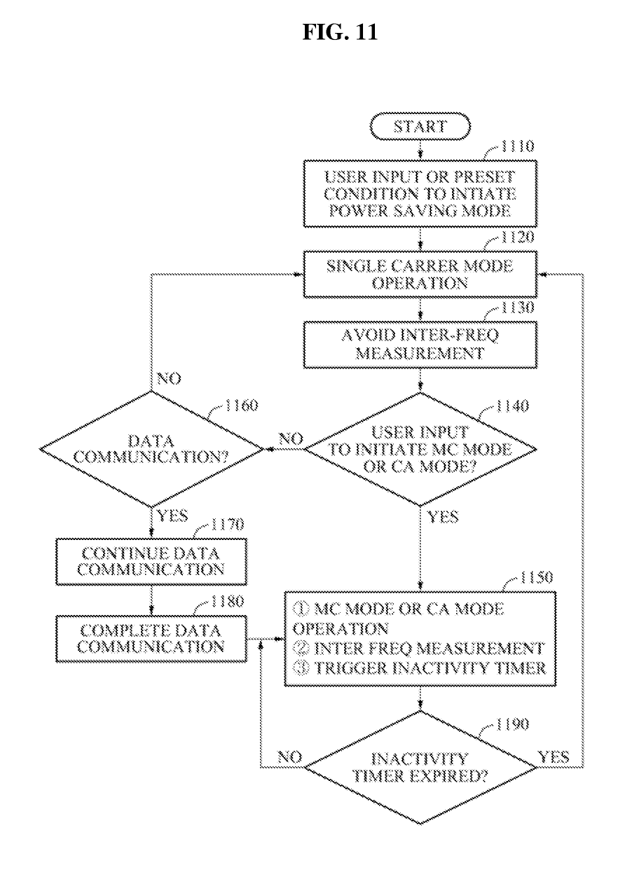

FIG. 11 is a flowchart illustrating a method for controlling a multi carrier supporting operation according to an exemplary embodiment of the present invention.

A mobile terminal may support a power saving mode (or an economy mode) to reduce battery consumption. The power saving mode may have different sub-modes in which various optional functions or operations are selectively restricted. If the mobile terminal supports a multi carrier mode or a carrier aggregation mode in which more than one frequency band is used, the mobile terminal may restrict the operation of the multi carrier mode or the carrier aggregation mode when the mobile terminal is operating in a multi-carrier operation restriction mode. The multi-carrier operation restriction mode may be a sub-mode of the power saving mode or included in the power saving mode such that the mobile terminal may restrict the operation of the multi carrier mode or the carrier aggregation mode when the mobile terminal is operating in the power saving mode. However, the multi-carrier operation restriction mode may is be activated based on different activation requirements. Examples of the different activation requirements will be described later in more detail. The mobile terminal may support LTE or LTE-Advanced (LTE-A) protocols, IEEE 802 protocols, and the like.

In operation 1110, a mobile terminal capable of supporting a multi-carrier mode or a carrier aggregation mode may switch its operation mode to a power saving mode. The power saving mode may be initiated by a user input requesting the power saving mode or a preset condition to initiate the power saving mode.

In operation 1120, the mobile terminal operates in a single carrier mode to save power consumption. For the single carrier mode, the mobile terminal, e.g., a user equipment (UE) supporting LTE and LTE-A protocols, may change mobile terminal capabilities (“UE capabilities”) to be operated in the single carrier mode. For example, the mobile terminal may set LTE band preference to “single carrier only” such that the mobile terminal restricts the use of the multi carrier mode or the carrier aggregation mode. The mobile terminal may report the preference change to the base station to which the mobile terminal is currently camped on. More specifically, if a multi-band preference is set for the mobile terminal, the mobile terminal may change the preference to “single carrier only” or to a single-band preference such that the mobile terminal uses a single band without utilizing the multi carrier mode or the carrier aggregation mode. The mobile terminal may report the changed UE capabilities to the base station.

In operation 1130, the mobile terminal does not perform inter-frequency measurement operations of a multi carrier mode or a carrier aggregation mode. As described above, the mobile terminal may save power consumption by avoiding the inter-frequency measurement operations of a multi carrier mode or a carrier aggregation mode.

In operation 1140, the mobile terminal may determine whether a user input to is initiate a multi carrier mode or a carrier aggregation mode is received. Further, the mobile terminal may determine whether a preset condition to initiate a multi carrier mode or a carrier aggregation mode is satisfied. If the user input is received, operation 1150 may be performed. Otherwise, operation 1160 may be performed.

In the operation 1150, multi carrier mode and/or the carrier aggregation mode may be initiated. The mobile terminal may or may not change mobile terminal capabilities (e.g., UE capabilities) and/or the band preference to multi carrier mode. The changed capabilities and the preference may be reported to the base station. More specifically, the mobile terminal may change the mobile terminal capabilities and/or the band preference to multi carrier mode when the mobile terminal exits from the power saving mode, and, in this scenario, the mobile terminal may not change the capabilities and preference in the operation 1150. Further, the mobile terminal may initiate inter-frequency measurements of the multi carrier mode or the carrier aggregation mode, and may trigger an inactivity timer. The inactivity timer may be a user inactivity timer used to determine the length of user inactivity, e.g., the time duration in which no user input is received, and/or a data communication inactivity timer used to determine the length of data communication inactivity, e.g., the time duration in which no data file download is performed, etc. However, aspects are not limited as such. The inactivity timer may be set based on different criteria.

In operation 1190, if it is determined that the inactivity timer is expired, the mobile terminal may return to the operation 1120 and initiate the single carrier mode. If it is determined that a user activity or a condition to maintain the multi carrier mode or the carrier aggregation mode occurs before the expiration of the inactivity timer, the mobile terminal may return to the operation 1150 and restart the inactivity timer.

If the user input to initiate a multi carrier mode or a carrier aggregation mode is not received or the preset condition to initiate a multi carrier mode or a carrier aggregation mode is not satisfied as determined in the operation 1140, the mobile terminal may determine whether a high volume data communication or a request for a data communication using the multi carrier mode or the carrier aggregation mode occurs in operation 1160. Before changing to the multi carrier mode or carrier aggregation mode in the operation 1150, the mobile terminal may perform and complete the data communication in operations 1170 and 1180. After completing the data communication, the mobile terminal may change the preferences and mobile terminal capabilities to initiate the multi carrier mode or the carrier aggregation mode in the operation 1150. However, aspects are not limited as such. For example, the mobile terminal may maintain the single carrier mode and perform the data communication using the single carrier mode, or the mobile terminal may initiate the multi carrier more or the carrier aggregation mode before performing the requested data communication.

If the mobile terminal exits from the power saving mode, the mobile terminal may change the mobile terminal capabilities and/or the band preference to multi carrier mode.

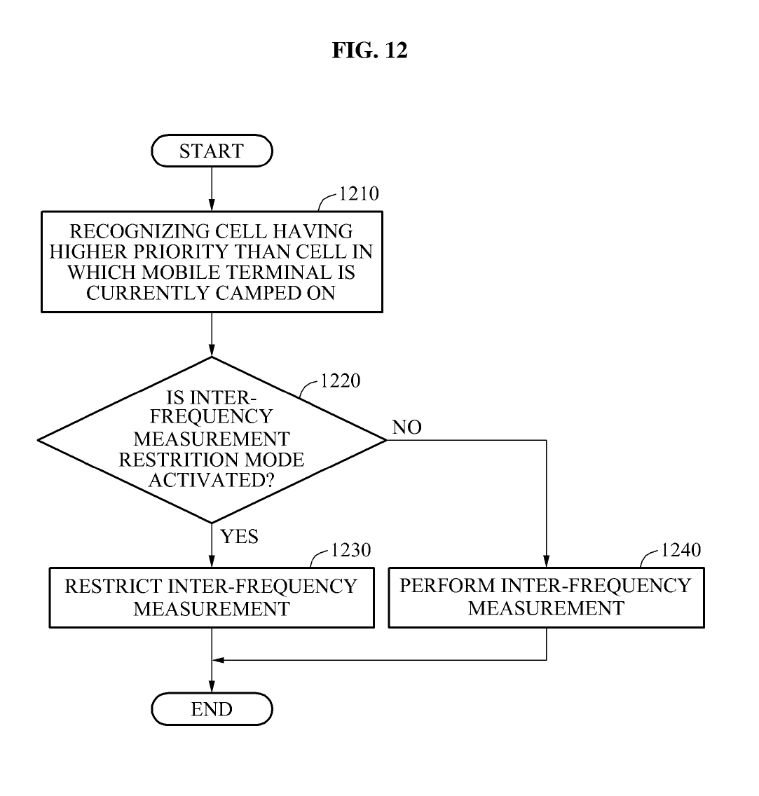

FIG. 12 is a flowchart illustrating a method for controlling a multi carrier supporting operation according to an exemplary embodiment of the present invention.

Referring to FIG. 12, a mobile terminal may be operating in an inter-frequency measurement restriction mode in which an inter-frequency measurement is restricted. In operation 1210, the mobile terminal may recognize a cell having higher priority than a cell in which the mobile terminal is currently camped on. In operation 1220, the mobile terminal may determine whether the inter-frequency measurement restriction mode is activated. If the inter-frequency measurement restriction mode is activated, the mobile terminal does not perform an is inter-frequency measurement with respect to another frequency band associated with the cell having higher priority than the cell in which the mobile terminal is currently camped on (operation 1230). If the inter-frequency measurement is not performed in the operation 1230, the mobile terminal may report to the base station such that the mobile terminal maintains the currently camped on cell and frequency resources. If the inter-frequency measurement restriction mode is not activated, the mobile terminal performs the inter-frequency measurement with respect to the other frequency band associated with the cell having higher priority than the cell in which the mobile terminal is currently camped on (operation 1240).

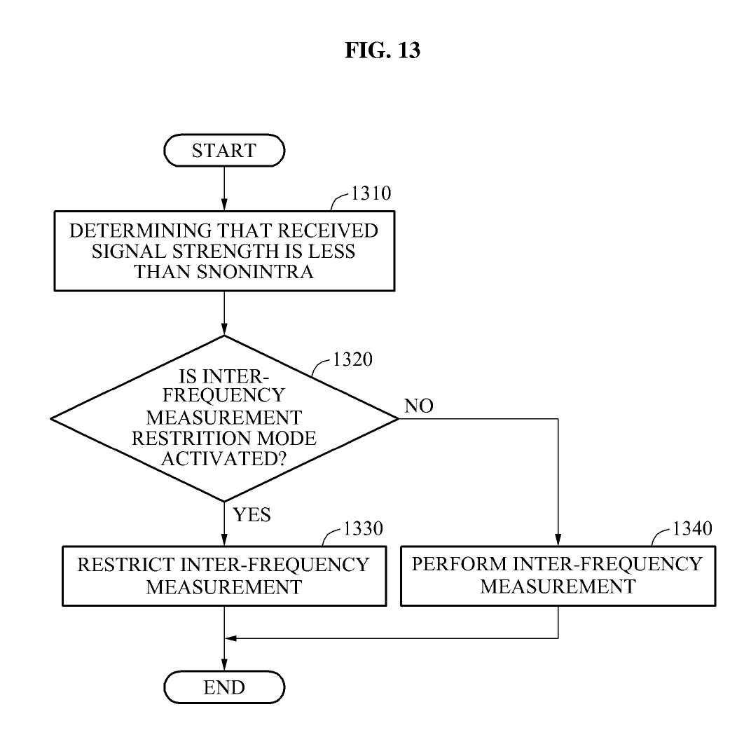

FIG. 13 is a flowchart illustrating a method for controlling a multi carrier supporting operation according to an exemplary embodiment of the present invention.

Referring to FIG. 13, a mobile terminal may be operating in an inter-frequency measurement restriction mode in which an inter-frequency measurement is restricted. In operation 1310, the mobile terminal may determine that received signal strength is less than Snonintra (or Snonintrasearch), which is a parameter that specifies the Srxlev threshold (e.g., in dB) for a mobile communication system, e.g., E-UTRAN, inter-frequency and inter-RAT (Radio Access Technology) measurements. The Srxlev denotes the cell selection receive level value and may be represented in decibel (dB). The parameters, e.g., Snonintra and the Srxlev, may be the parameters defined in Wideband Code Division Multiple Access (W-CDMA), Long Term Evolution (LTE), or LTE-Advanced specifications, but are not limited thereto. In operation 1320, the mobile terminal may determine whether the inter-frequency measurement restriction mode is activated. If the inter-frequency measurement restriction mode is activated, the mobile terminal does not perform an inter-frequency measurement with respect to another frequency band (operation 1330). If the inter-frequency measurement is not performed in the operation 1330, the is mobile terminal may report to the base station such that the mobile terminal maintains the currently camped on cell and frequency resources. If the inter-frequency measurement restriction mode is not activated, the mobile terminal performs the inter-frequency measurement with respect to the other frequency band (operation 1340).

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device may access, store, manipulate, process, and create data in response to executions of the software. For purpose of simplicity, the description of a processing device is used as singular; however, a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device capable of providing instructions or data to or being interpreted by the processing device. The software also may be distributed over network coupled computer is systems so that the software is stored and executed in a distributed fashion. In particular, the software and data may be stored by one or more non-transitory computer readable recording mediums.

The method according to the exemplary embodiments of the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media such as hard disks, floppy disks, and magnetic tape; optical media, such as CD ROM discs and DVD; magneto-optical media, such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method that uses a processor to control a multi-carrier supporting operation of a mobile terminal, the method comprising:
determining whether a power saving condition is satisfied;
determining whether the mobile terminal is operating in a multi carrier mode or a carrier aggregation mode; and
if the power saving condition is satisfied, restricting, by the processor, an inter-frequency measurement of the multi carrier mode or an inter-frequency measurement of the carrier aggregation mode.

2. The method of claim 1, wherein:
in the multi carrier mode, the mobile terminal is capable of switching between multiple frequency bands, and
in the carrier aggregation mode, the mobile terminal is capable of utilizing aggregated multiple frequency bands or aggregated multiple component carriers.

3. The method of claim 1, further comprising:
initiating a single carrier mode if the power saving condition is satisfied, the single carrier mode utilizing a single frequency band.

4. The method of claim 3, further comprising:
in the single carrier mode, restricting an inter-frequency measurement with respect to another frequency band other than the single frequency band.

5. The method of claim 3, further comprising:
if the power saving condition is satisfied, changing a mobile terminal capability or a frequency band preference to the single carrier mode.

6. The method of claim 5, further comprising:
reporting, to a base station, the changed mobile terminal capability or the frequency band preference.

7. The method of claim 3, wherein, if the power saving condition is satisfied, the multi carrier mode or the carrier aggregation mode is activated from the single carrier mode based on a user input or a condition to initiate the multi carrier mode or the carrier aggregation mode.

8. The method of claim 7, further comprising:
operating an inactivity timer when the multi carrier mode or the carrier aggregation mode is activated and the power saving condition is satisfied.

9. The method of claim 8, further comprising:
switching back to the single carrier mode if the inactivity timer expires and the power saving condition is satisfied.

10. The method of claim 3, further comprising:
if the power saving condition is released, operating the mobile terminal in the multi carrier mode or the carrier aggregation mode.

11. The method of claim 1, further comprising:
if the power saving condition is released, changing a mobile terminal capability or a frequency band preference to the multi carrier mode or the carrier aggregation mode.

12. The method of claim 1, further comprising:
restricting the at least one of the inter-frequency measurement of the multi carrier mode and the inter-frequency measurement of the carrier aggregation mode based on at least one of an application execution state and a data usage pattern.

13. A mobile terminal to control a multi-carrier supporting operation, comprising:
a processor to determine whether a power saving condition is satisfied and to restrict at least one of an inter-frequency measurement of a multi carrier mode and an inter-frequency measurement of a carrier aggregation mode if the power saving condition is satisfied.

14. The mobile terminal of claim 13, wherein:
in the multi carrier mode, the mobile terminal is capable of switching between multiple frequency bands, and
in the carrier aggregation mode, the mobile terminal is capable of utilizing aggregated multiple frequency bands or aggregated multiple component carriers.

15. The mobile terminal of claim 13, wherein the processor initiates a single carrier mode if the power saving condition is satisfied, the single carrier mode utilizing a single frequency band.

16. The mobile terminal of claim 15, wherein, in the single carrier mode, the processor restricts an inter-frequency measurement with respect to another frequency band other than the single frequency band.

17. A method that uses a processor to control a multi-carrier supporting operation of a mobile terminal, the method comprising:
determining whether an inter-frequency measurement restriction mode is activated;
determining whether a condition to perform an inter-frequency measurement of a multi carrier mode or an inter-frequency measurement of a carrier aggregation mode is satisfied; and
if the inter-frequency measurement restriction mode is activated, restricting, by the processor, the inter-frequency measurement of the multi carrier mode or the inter-frequency measurement of the carrier aggregation mode.

18. The method of claim 17, wherein:
in the multi carrier mode, the mobile terminal is capable of switching between multiple frequency bands, and
in the carrier aggregation mode, the mobile terminal is capable of utilizing aggregated multiple frequency bands or aggregated multiple component carriers.

19. The method of claim 18, wherein the condition to perform an inter-frequency measurement of a multi carrier mode or an inter-frequency measurement of a carrier aggregation mode comprises:
a determination that at least one detectable inter-frequency cell has a higher priority than a cell in which the mobile terminal is camped on.

20. The method of claim 18, wherein the condition to perform an inter-frequency measurement of a multi carrier mode or an inter-frequency measurement of a carrier aggregation mode comprises:
a determination that a value of received signal strength of the mobile terminal is less than Snonintra.
